(19) United States
(12) Patent Application Publication
(10) Pub. No.: US 2025/0193213 A1
(43) Pub. Date: Jun. 12, 2025

(54) RAPID IDENTIFICATION OF MALICIOUS CYBER ACTIVITY AND CONTEXTUALIZATION OF INDICATORS OF COMPROMISE

(71) Applicant: SAUDI ARABIAN OIL COMPANY, Dhahran (SA)

(72) Inventors: Michael Bradford Gilliam, Dhahran (SA); Marwan Yasir Rafie, Dhahran (SA)

(73) Assignee: SAUDI ARABIAN OIL COMPANY, Dhahran (SA)

(21) Appl. No.: 18/533,299

(22) Filed: Dec. 8, 2023

(51) Int. Cl. H04L 9/40

(52) U.S. Cl. CPC H04L 63/1416; H04L 63/1425; H04L 63/1441

(57) ABSTRACT

A computer-implemented system and method are provided for processing information representing indicators of compromise for automatic cyberthreat assessment and remediation. Processor(s) automatically access information representing indicators of compromise and can further identify a subset of at least some of the information representing the indicators of compromise. The processor(s) generate, using the identified subset, a request for contextual information and, thereafter, transmit the request. The processor(s) further receive, from the database in response to the request, a plurality of structured data records including the contextual information. The processor(s) can determine that at least one of the structured data records includes contextual information associated with a malicious cyberthreat. The processor(s) can output information representing the contextual information included in the structured data record(s) and the indicators of compromise associated with the at least some of the data records, as well as take remedial action using the output information.

### FIELD OF THE DISCLOSURE

The present disclosure relates generally to cybersecurity, and, more particularly, to a system and method for rapidly identifying malicious cyberactivity that correspond to indicators of compromise.

### BACKGROUND OF THE DISCLOSURE

Enterprise-level information technology networks require ongoing security operations, including investigations associated with cybersecurity attacks and threats. Such attacks and threats can include unauthorized access to private information, files, and networks to steal, disrupt, damage, or otherwise negatively impact operations. Investigations of network activity can include, for example, identifying unusual network traffic (e.g., outbound network traffic), unusual account activity, network activity originating from irregular geographic locations, irregular log-in activity, and changes in database access and activity. Information associated with such network activity is referred to herein, generally, as “indicators of compromise,” which can be represented in various formats, such as system logs that are maintained by the enterprise.

Information representing network activity, including indicators of compromise, do not necessarily represent deliberate cybersecurity attacks or threats of attack in a network. Some network activity may appear to be unusual or irregular, but is simply innocent end-user error or authorized activity in accordance with one or more changes in operations. Accordingly, network administrators cannot rely exclusively on indicators of compromise to represent malicious cyber activity, such as threats or attacks, and indicators of compromise require additional investigation before a determination of a cyberattack or threat thereof can be made conclusively.

It is respect to these and other concerns that the present disclosure is made.

### SUMMARY OF THE DISCLOSURE

In accordance with aspects of the present disclosure, a computer-implemented system and method are provided for processing information representing indicators of compromise for automatic cyberthreat assessment and remediation. One or more processors can have access to program instructions that, when executed, cause the one or more processors to automatically access information representing indicators of compromise. The one or more processors can further identify a subset of at least some of the information representing the indicators of compromise. Further, the one or more processors generate, using the identified subset, a request for contextual information and, thereafter, transmit the request. The one or more processors can further receive, from the database in response to the request, a plurality of structured data records including the contextual information. Moreover, the one or more processors can determine that at least one of the structured data records includes contextual information associated with a malicious cyberthreat. The one or more processors can output information representing the contextual information included in the at least one of the structured data records and the indicators of compromise associated with the at least some of the data records, as well as take remedial action using the output information.

In accordance with further aspects of the present disclosure, the structured data record is a Javascript Object Notation (“JSON”) object, the request is transmitted in an application programming interface (“API”) call, and the output is a comma separated value (“CSV”) file. In addition, the one or more processors further can have access to program instructions that, when executed, cause the one or more processors to automatically process each of a plurality of JSON objects in parallel. Moreover, the database includes contextual information that is provided from a plurality of data sources, which can include open source intelligence.

In accordance with further aspects of the present disclosure, at least some of the contextual information includes at least one of a file name, a hash value, a domain address, and an internet protocol address. Further, the contextual information in the database can represent the indicators of compromise as malicious, non-malicious, or falsely positive. Moreover, the remedial action includes detecting and containing a cyberthreat.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

Aspects of the present disclosure will be more readily appreciated upon review of the detailed description of its various embodiments, described below, when taken in conjunction with the accompanying drawings, of which:

FIG. 1 is a block diagram illustrating an example source computing system and associated components in accordance with an example implementation of the present disclosure;

FIG. 2 illustrates computing system and associated components shown in FIG. 1;

FIG. 3 is a flowchart representing an example process flow, showing threats associated with indicators of compromise in accordance with an example implementation of the present disclosure; and

FIG. 4 illustrates an example process associated with processing a generated (e.g., CSV) output file, in accordance with an example implementation of the present disclosure.

### DETAILED DESCRIPTION OF CERTAIN EMBODIMENTS OF THE DISCLOSURE

Threats associated with indicators of compromise frequently require information for an accurate conclusion that a cyberattack or cyberthreat to been made. For example, information representing a source and time of a conducted attack, identifier(s) associated with a file (e.g., a file hash, file name, file size, or other identifier), method of attack, and a command and control infrastructure, can be analyzed to determine that a cyberattack or cyberthreat in connection with an indicator of compromise has been made. Example cyberattacks and cyberthreats can include malware, phishing, denial of service attacks, and ransomware. Information derived from available sources, referred to herein, generally, as “open source intelligence” can reference indicators of compromise in previously known conducted attacks, as well as internal intelligence gathered from security devices configured in the organization. Ingesting such information can help analysts contextualize and link the information to the attributed indicators of compromise.

Collecting data associated with indicators of compromise can be time-consuming and the analysis associated therewith daunting. Certain kinds of information can be particularly time-consuming and difficult to obtain and analyze. Moreover, not all information is accessible and can require context and validation to be useful. a respective indicator of compromise, for example, may only showcase that it has appeared fewer than 5 times and was seen from only one reporting credible source. This can require an analyst to investigate and research more areas to identify potential other reported sources to classify respective indicators of compromise as critical and requiring a response.

The present disclosure provides systems and methods that improve accuracy in detecting cybersecurity attacks and threats as a basis of detected indicators of compromise. In one or more implementations, automatic processes are provided that ensure information associated with indicators of compromise used to determine the existence of malicious cyberactivity is accurate and reliably obtained. For example, programming routines are executed by one or more processors that perform searching and processing of results. Automatic processing reduces time and effort, and increases accuracy and consistency that would otherwise be incurred by manual searching and processing.

Furthermore, the present disclosure includes one or more processors identifying cybersecurity attacks and threats rapidly, including by generating contextual information associated with indicators of compromise. Contextual Information can include a reporting party identification, such as individual or organization, a confidence of maliciousness of a respective indicator of compromise, a number of times an indicator of confidence is detected, and respective tags or comments associated with an indicator of compromise. The contextualized information can be accessed from, for example, an internal cybersecurity repository and used to generate context for a file name, file hash, domain address, or IP address, for example. In one or more implementations, generating contextual information can include making an API call to a repository, which can create a query and return results from the repository as a structured data record including, but not limited to, a JAVASCRIPT OBJECT NOTATION (“JSON”) format.

Accordingly, the present disclosure provides integrated and automatic processes, which advantageously increase efficiency and effectiveness in detecting cybersecurity matters rapidly. For example, an output file can be generated in an MS-EXCEL, with worksheet tabs that are organized based on severity. Analysts can detect cybersecurity matters, for example, by focusing on indicators organized in worksheets demarcated as “Critical,” for rapid investigation and remediation. Remediation can include detecting and containing threats.

In one or more implementations, the present disclosure includes one or more processors that execute programming routines to distinguish cyberactivity that is malicious and potentially dangerous, including threats and attacks, from cyberactivity that is not. For example, cyberactivity that includes authorized personnel or devices accessing or attempting to access information in the enterprise can be detected rapidly and determined to be safe and not an attack or threat. Alternatively, information associated with indicators of compromise can be processed to detect malicious cyberactivity and to generate and display corresponding information in a manner that quickly and accurately highlights items that require immediate security attention. Analysts can access a list of indicators of compromise and perform a search against all systems, which can alert them if any hits are matched, and the analysts can take remedial action, accordingly. In one or more implementations, remedial action can be taken automatically by one or more computing devices

The present disclosure includes steps associated with compiling a list of multiple indicators of compromise, which can be compared against known malicious behavior. For example, cyberactivity associated with indicators of compromise that are performed elsewhere or previously can be identified and processed to determine whether such cyberactivity includes an attack or threat thereof. Thereafter, the indicators of compromise can be enriched by using one or more intelligence sources, such as VIRUSTOTAL, which provides context that the activity performed by the offending indicators of compromise. Proprietary intelligence providers can be ingested into an internal cybersecurity repository. Further, indicators of compromise can be updated by proprietary intelligence providers or the analyst themselves, for example once determined to be representing safe cyber activity. For example, results can be compared against an internal repository of past and current cybersecurity activity.

The present disclosure combines multiple data sources to improve the ability to determine relevancy based upon correlation of seemingly insignificant details, once combined with additional relevant information. The above-mentioned internal repository can contain multiple components having relevance dependent upon a respective type of the item of interest and the activity attempter. There are multiple factors that can be evaluated when attempting the correlation, to maximize the accuracy.

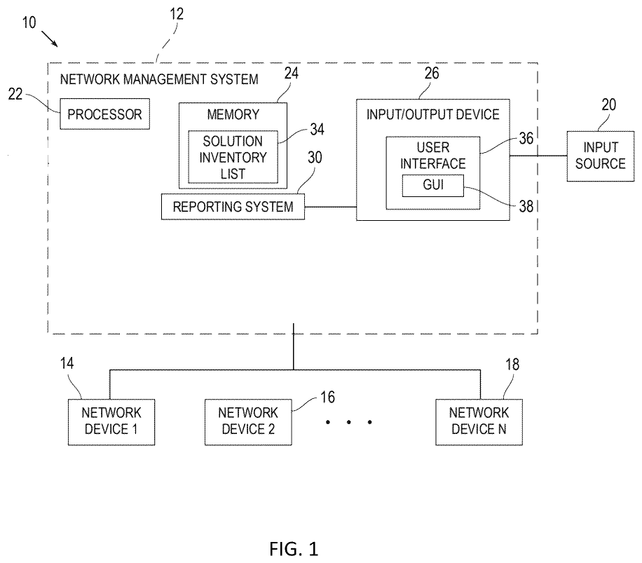

Referring now to the drawings, FIG. 1 illustrates a system 10 includes a network management system 12 operatively connected to a plurality of network devices 14, 16, 18. Each network device 14, 16, 18 can be a computing device configured to communicate with users or with other computing devices. For example, a network device can be a hub for other computing devices. The network management system 12 is also connected to an external input source 20. The external input source 20 can be a computing device configured to provide information to the network management system 12. For example, the input source 20 provide a commercial security product configured to protect at least one of the network devices 14, 16, 18. Alternatively, the input source 20 can provide an open-source solution to configure at least one of the network devices 14, 16, 18. In another alternative embodiment, the input source 20 can be information configured to provide direct analyst access to automate various tasks to be performed on at least one of the network devices 14, 16, 18.

The network management system 12 can be operatively connected to the components 14, 16, 18, 20 by communication channels, such as a network. The communication channels can include wired communications. Alternatively, the communication channels can be wireless communications. In other alternative embodiments, the communication channels can be implemented by an Ethernet, Wi-Fi, Bluetooth, or USB interface. The communication channels can be implemented by any known communication channel devices and communication protocols. The communication channels configured as the network can include the Internet. Alternatively, the communication channels configured as the network can be an intranet of an organization. In a further alternative embodiment, the communication channels configured as the network can be any known network having the network devices 14, 16, 18 and other connected devices such as the input source 20.

The processor 22 can be any known processing device or system, as described below, with code or instructions configured to perform network management of the network devices 14, 16, 18. The processor 22 can coordinate and control the operations of the components 24-46 of the network management system 12, as described below. The memory 24 can be any known data storage device or system, as described below. The memory 24 is configured to store a solution inventory list 34. The solution inventory list 34 stores network device solutions to configure respective network devices. The input/output device 26 can be any known information management device, as described below, configured to receive inputs and data and to output data. In an alternative embodiment, the input/output device 26 can include an input device separate from an output device, with the input device configured to receive inputs and data, and the output device configured to output data. The input/output device 26 is further configured to interact with a user. The inputs received by the input/output device 26 can be data or commands from the user, such as a system administrator of the system 10. The system administrator can interact with the network management system 12 to control and configure the network devices 14, 16, 18. The data received by the input/output device 26 can be data from an input source 20, as described below. For example, the received data can include a list of Internet Protocol (IP) addresses of all network devices 14, 16, 18. In addition, the received data can include a list of commands configured to control the network management system 12 to manage the network devices 14, 16, 18. The input source 20 can be operatively connected to the input/output device 26 using a known communication channel, as described herein.

The outputs of the input/output device 26 can be data or information displayed or otherwise conveyed to a user, as described below. The input/output device 26 can be configured to operate using an application programming interface (API). For example, the API can include a representational state transfer (RESTful) API configured to allow interfacing with any known input sources, such as the input source 20. The input/output device 26 is provided with a user interface (UI) 36. The user interface 36 can be any known user interface. The input/output device 26 can include an interactive display, and the input/output device 26 can be configured to display a graphic user interface (GUI) 38 through the user interface 36.

The reporting system 30 is configured to generate a report in a known format. For example, the report can be in the Portable Document Format (PDF), can be in HyperText Markup Language (HTML), can be in Standard Generalized Markup language (SGML), can be in Extensible Markup Language (XML), can be text, or can be an Email. The reporting system 30 is operatively connected to the input/output device 26. The reporting system 30 can also be configured to send a generated report to the input/output device 26 to be output to a user.

The interactive system 32 is configured to interact with at least one of the network devices 14, 16, 18.

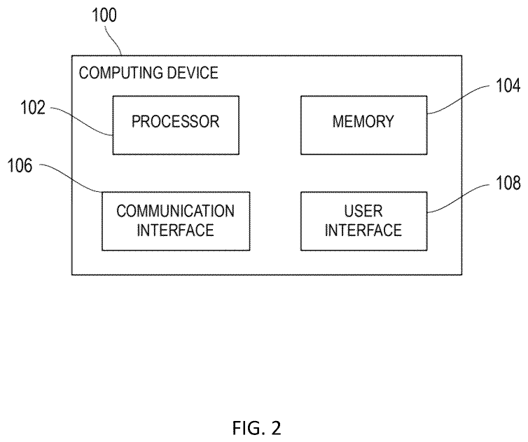

FIG. 2 illustrates a schematic of a computing device 100 including a processor 102 having code therein, a memory 104, and a communication interface 106. Optionally, the computing device 100 can include a user interface 108. The processor 102, the memory 104, the communication interface 106, and the user interface 108 can be operatively connected to each other via any known connections, such as a system bus, a network, etc. Any component or combination of components of the system 10 in FIG. 1 can be implemented by a respective computing device 100. For example, each of network management system 12, the network devices 14, 16, 18, the input/output device 26, AND the reporting system 30 shown in FIG. 1 can be implemented by a respective computing device 100 shown in FIG. 2 and described below.

It is to be understood that the computing device 100 can include different components. Alternatively, the computing device 100 can include additional components. In another alternative embodiment, some or all of the functions of a given component can instead be carried out by one or more different components. The computing device 100 can be implemented by a virtual computing device. Alternatively, the computing device 100 can be implemented by one or more computing resources in a cloud computing environment. Additionally, the computing device 100 can be implemented by a plurality of any known computing devices.

The processor 102 can include one or more general-purpose processors. Alternatively, the processor 102 can include one or more special-purpose processors. The processor 102 can be integrated in whole or in part with the memory 104, the communication interface 106, and the user interface 108. In another alternative embodiment, the processor 102 can be implemented by any known hardware-based processing device such as a controller, an integrated circuit, a microchip, a central processing unit (CPU), a microprocessor, a system on a chip (SoC), a field-programmable gate array (FPGA), or an application-specific integrated circuit (ASIC). In addition, the processor 102 can include a plurality of processing elements configured to perform parallel processing. In a further alternative embodiment, the processor 102 can include a plurality of nodes or artificial neurons configured as an artificial neural network. The processor 102 can be configured to implement any known artificial neural network, including a convolutional neural network (CNN).

The memory 104 can be implemented as a non-transitory computer-readable storage medium such as a hard drive, a solid-state drive, an erasable programmable read-only memory (EPROM), a universal serial bus (USB) storage device, a floppy disk, a compact disc read-only memory (CD-ROM) disk, a digital versatile disc (DVD), cloud-based storage, or any known non-volatile storage.

The code of the processor 102 can be stored in a memory internal to the processor 102. The code can be instructions implemented in the hardware processor 102. In alternative implementations, the code can be instructions implemented in software. The instructions can be machine-language instructions executable by the processor 102 to cause the computing device 100 to perform the functions of the computing device 100 described herein. Alternatively, the instructions can include script instructions executable by a script interpreter configured to cause the processor 102 and computing device 100 to execute the instructions specified in the script instructions. In another alternative embodiment, the instructions are executable by the processor 102 to cause the computing device 100 to execute an artificial neural network.

The memory 104 can store data in any known format, such as databases, data structures, data lakes, or network parameters of a neural network. The data can be stored in a table, a flat file, data in a filesystem, a heap file, a B+ tree, a hash table, or a hash bucket. The memory 104 can be implemented by any known memory, including random access memory (RAM), cache memory, register memory, or any other known memory device configured to store instructions or data for rapid access by the processor 102, including storage of instructions during execution.

The communication interface 106 can be any known device configured to perform the communication interface functions of the computing device 100 described herein. The communication interface 106 can implement wired communication between the computing device 100 and another entity. Alternatively, the communication interface 106 can implement wireless communication between the computing device 100 and another entity. The communication interface 106 can be implemented by an Ethernet, Wi-Fi, Bluetooth, or USB interface. The communication interface 106 can transmit and receive data over the network 14 and to other devices using any known communication link or communication protocol.

The user interface 108 can be any known device configured to perform user input and output functions, to implement the user interface 36 and the graphic user interface 38 shown in FIG. 1. The user interface 108 can be configured to receive an input from a user. Alternatively, the user interface 108 can be configured to output information to the user. The user interface 108 can be a computer monitor, a television, a loudspeaker, a computer speaker, or any other known device operatively connected to the computing device 100 and configured to output information to the user. A user input can be received through the user interface 108 implementing a keyboard, a mouse, or any other known device operatively connected to the computing device 100 to input information from the user. Alternatively, the user interface 108 can be implemented by any known touchscreen. The computing device 100 can include a server, a personal computer, a laptop, a smartphone, or a tablet.

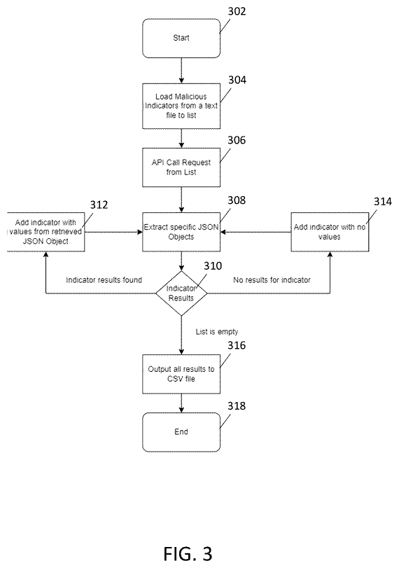

FIG. 3 illustrates an example process of generating an output file, such as a comma separated value (“CSV”) file, showing threats associated with indicators of compromise in accordance with an example implementation of the present disclosure. At step 302, the process starts and, thereafter, at step 304, a text file is accessed that includes malicious cyberactivity associated with indicators of compromise and the identified malicious indicators are loaded into a list. The internal repository can contain items that are identified as malicious or benign, as well as items that are categorized as false-positives, which are usable to leverage previous determinations while performing future analysis. The text file can contain, for example, a list of indicators of compromise that an analyst has gathered from multiple streams of sources, and can contain a multitude of benign or malicious examples of cyberactivity.

At step 306, an application programming interface (“API”) call request is made from the list to a cybersecurity repository. The API call can contain information from the list to enable results to be included in the analysis.

At step 308, a specific JSON object is extracted that correlates with a respective record in the list. In one or more implementations, the JSON object can be extracted with objects being analyzed in a parallel fashion, as opposed to serially, which improves efficiency. The information can be stored in the cybersecurity repository. Some examples of the result can contain the name of the indicator of compromise (IOC), the type of the IOC (e.g filename, file hash, IP address, or other unique details), or the number of times it was observed by internal or external intelligence sources.

At step 310, a determination is made whether a result representing malicious cyberactivity, such as a cybersecurity attack or threat, is associated with the respective indicator of compromise identified in the list. The determination can depend upon the information that is extracted from the repository. For example, certain information can be weighted and a final score assigned.

In the event that indicator results are found, then the process branches to step 312 and the indicator is added with values from the retrieved JSON object. Thereafter, the process continues to step 308. Alternatively, if the determination in step 310 is that no results are found for the indicator, then the process branches to step 316 and the indicator with no values is added.

After all items in the list have been processed (i.e., the list is “empty”), then the process branches to step 318 and the results are output, for example, to a CSV file. Thereafter, the process ends at step 320.

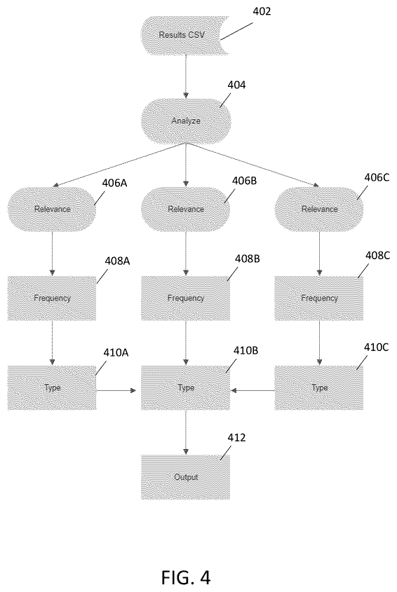

FIG. 4 illustrates an example process associated with a generated (e.g., CSV) output file, in accordance with an example implementation of the present disclosure. At step 402, the results (CSV) file is accessed and at step 404, the results are analyzed. The information retrieved from the internal repository can be stored in a manner enabling a formula can effectively extract the necessary threat level, effectiveness, and expected threat level associated with future occurrences.

Thereafter, the process branches to steps 406A, 406B, 406C, and a determination of relevance is made, including a determination that the item is either an actively used indicator of compromise, an inactive indicator of compromise, or a false positive. The process respectively continues to steps 408A, 408B, 408C and a determination of frequency is made. This step determines, for example, how many times the indicator of compromise was seen (i.e., the frequency) to provide additional information. The logic of determining whether the indicator of compromise is either active, inactive or a false positive is fetched from an internal cybersecurity repository. This is a pre-determined requirement set by either an intelligence source (proprietary or open source) or by the analyst themselves who is maintaining and updating all relevant indicators of compromise inside the cybersecurity repository. Human intervention to determine the following three states is mandatory.

Thereafter, the process continues to steps 410A, 410B, 410C, respectively, and a determination of type is made. This step determines the type of indicator of compromise to help its contextualization. Examples can include IP addresses, file hashes, email addresses, or the like. Thereafter, the process continues to step 412, and an output step occurs. The output can be generated as a CSV output.

Thus, the present disclosure provides additional insight into the possible adversarial objectives and possible magnitude of threats, as a function of indicators of compromise. Such insights can be provided via a comprehensive, intelligent search that analyzes historical data for similar activities. Once found, relevant information can be extracted and used to enrich the data to provide additional relevant and appropriate data.

Portions of the methods described herein can be performed by software or firmware in machine readable form on a tangible (e.g., non-transitory) storage medium. For example, the software or firmware can be in the form of a computer program including computer program code adapted to cause the system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A computer-implemented method for processing information representing indicators of compromise for automatic cyberthreat assessment and remediation, the method comprising:
automatically accessing, by at least one computing device configured by executing instructions, information representing indicators of compromise;
automatically identifying, by the at least one computing device, a subset of at least some of the information representing the indicators of compromise;
automatically generating, by the at least one computing device using the identified subset, a request for contextual information;
automatically transmitting, by the at least one computing device to a database, the request;
automatically receiving, from the database in response to the request, a plurality of structured data records including the contextual information;
automatically determining, by the at least one computing device, that at least one of the structured data records includes contextual information associated with a malicious cyberthreat;
automatically output, by the at least one computing device, information representing the contextual information included in the at least one of the structured data records and the indicators of compromise associated with the at least some of the data records; and
automatically taking remedial action, by the at least one computing device, using the output information.

2. The computer-implemented method of claim 1, wherein the structured data record is a Javascript Object Notation (“JSON”) object, the request is transmitted in an application programming interface (“API”) call, and the output is a comma separated value (“CSV”) file.

3. The computer-implemented method of claim 2, further comprising processing, by the at least one computing device, each of a plurality of JSON objects in parallel.

4. The computer-implemented method of claim 1, wherein the database includes contextual information is provided from a plurality of data sources.

5. The computer-implemented method of claim 1, wherein the data sources include open source intelligence.

6. The computer-implemented method of claim 1, wherein at least some of the contextual information includes at least one of a file name, a hash value, a domain address, and an internet protocol address.

7. The computer-implemented method of claim 1, wherein the contextual information in the database represents the indicators of compromise as malicious, non-malicious, or falsely positive.

8. A computer-implemented system for processing information representing indicators of compromise for automatic cyberthreat assessment and remediation, the method comprising:
one or more processors, the one or more processors having access to program instructions that, when executed, cause the one or more processors to automatically:
access information representing indicators of compromise;
identify a subset of at least some of the information representing the indicators of compromise;
generate, using the identified subset, a request for contextual information;
transmit the request;
receive, from the database in response to the request, a plurality of structured data records including the contextual information;
determine that at least one of the structured data records includes contextual information associated with a malicious cyberthreat;
output information representing the contextual information included in the at least one of the structured data records and the indicators of compromise associated with the at least some of the data records; and
take remedial action using the output information.

9. The computer-implemented system of claim 8, wherein the structured data record is a Javascript Object Notation (“JSON”) object, the request is transmitted in an application programming interface (“API”) call, and the output is a comma separated value (“CSV”) file.

10. The computer-implemented system of claim 9, wherein the one or more processors further have access to program instructions that, when executed, cause the one or more processors to automatically process each of a plurality of JSON objects in parallel.

11. The computer-implemented system of claim 8, wherein the database includes contextual information is provided from a plurality of data sources.

12. The computer-implemented system of claim 8, wherein the data sources include open source intelligence.

13. The computer-implemented system of claim 8, wherein at least some of the contextual information includes at least one of a file name, a hash value, a domain address, and an internet protocol address.

14. The computer-implemented system of claim 8, wherein the contextual information in the database represents the indicators of compromise as malicious, non-malicious, or falsely positive.

15. The computer-implemented system of claim 8, wherein the remedial action includes detecting and containing a cyberthreat.
